(19) United States
(12) Patent Application Publication
(10) Pub. No.: US 2026/0328705 A1
(43) Pub. Date: Oct. 22, 2026

(54) MECHANICAL DEVICE FOR INSPECTING PARTS

(71) Applicant: Totems Position Sàrl, Dombresson (CH)

(72) Inventor: Toni Orhanovic, Dombresson (CH)

(73) Assignee: Totems Position Sàrl, Dombresson (CH)

(21) Appl. No.: 19/490,059

(22) PCT Filed: Jun. 5, 2024
(86) PCT No.: PCT/IB2024/055485

§ 371 Date: Dec. 4, 2025

(30) Foreign Application Priority Data
Jun. 6, 2023 (CH) CH000596/2023

(51) Int. Cl. G01N 21/952; G01N 21/88

(52) U.S. Cl. CPC G01N 21/952; G01N 21/8806

(57) ABSTRACT

The invention relates to a mechanical device for inspecting rotationally symmetrical parts (6) or machined parts. The mechanical device is suitable for a vertical optical inspection apparatus comprising an image sensor (1) and an observation surface (7). The mechanical device comprises a stationary base (3), a frame (4) that is tiltably mounted on the stationary base (3), and one or more positioning elements (5) mounted on the tiltable frame (4). The or each positioning element (5) is arranged to receive at least one part (6) of which an image can be captured by the image sensor (1) of the vertical optical inspection apparatus when the stationary base (3) of the mechanical device is positioned on the observation surface (7) of said apparatus (7). The mechanical device is arranged to allow the frame (4) comprising the or each positioning element (5) to tilt so as to position the axis of rotational symmetry of the or each rotationally symmetrical part (6) or a face to be inspected of the or each machined part, perpendicularly to the optical axis of the vertical optical inspection apparatus.

### TECHNICAL FIELD

The present invention relates to a mechanical device for inspecting parts, for example parts manufactured by turning, stamped and bent parts, or machined parts, with an optical inspection means whose elements are arranged in a vertical axis.

### BACKGROUND ART

Turned, stamped, bent, and machined parts often have a variety of geometries that make it difficult to position, orient, and hold them during inspection with optical inspection apparatus, known as vertical apparatus.

The difference in diameter and height of the faces of the parts to be inspected implies that when certain parts are placed directly on the horizontal measuring table, which is perpendicular to the optical axis of the inspection apparatus, they become unstable and sometimes roll on the table. This results in potential instability and a lack of perpendicularity with respect to the optical axis of the inspection apparatus. Under these conditions, the detection of the contours of the parts used for measurement is potentially distorted and the parts cannot be inspected accurately and repeatedly.

There are various solutions and approaches to address these positioning issues. In general, a fixture that supports and compensates for dimensional variations in the support areas will be used.

For rotationally symmetrical parts, when the geometry and material of the parts allow it, an axial positioning approach will be used whenever possible. This can take the form of positioning on a pin or clamping between two pointed pins for parts with an axial bore, or with hollow pins for parts without a bore.

There are also positioning methods using partial magnetic levitation, as well as holding methods based on vacuum suction. All these methods have the advantage of ensuring the perpendicular positioning of the parts, as they align with the axial areas of the part. However, they have the disadvantage of sometimes obscuring or interfering with the detection of a portion of the part to be measured.

There are also positioning devices based on V-shaped support profiles. Depending on the thickness of the support profile, which can be made very thin, the portion of the part that is hidden is minimal and therefore does not interfere with the measurement. However, this method requires an adjustment to compensate for the dimensional differential between the two support areas in order to achieve perpendicular positioning of the part. The narrowness of the support surface of such a device can make the positioning of small parts or parts with a significantly offset centre of gravity unstable and ergonomically difficult.

Other approaches to some extent eliminate the need for truing by positioning the parts between two inclined transparent walls. In such devices, the part orients itself under the effect of gravity, and if it makes proper contact with both walls along its entire length, it can be measured perpendicularly, provided that it is observed in a horizontal plane and therefore perpendicular to the optical axis of a vertically oriented apparatus. The drawback of this method lies in the need for an inspection apparatus whose optical control axis is arranged horizontally, which is not standard, or in arranging angle-transfer apparatus so that the image coming from a horizontal axis is conveyed to an optically vertical sensor. The degree of inclination of the transparent walls remains limited, since if the angle were too wide, the edges of the walls could interfere with the proper horizontal detection of the part to be measured. As a result, parts having a significant differential between their two support diameters over a short length will not make symmetrical contact with both walls and therefore could not be measured. As a further potential drawback, it should be noted that image measurement of parts viewed through one or more intermediate surfaces, regardless of their degree of transparency, may be affected by reflections and optical distortions.

For stamped, bent, and machined parts that do not lie flat and are by definition not rotationally symmetrical parts, they will most often be clamped in a fixed chuck if the clamping area allows perpendicular alignment of the face to be measured, or in a rotary chuck that will be oriented until a perpendicular position is obtained.

All of the methods described above have certain advantages and disadvantages. Depending on the size of the parts to be measured, one method may be more suitable than the others at a given time. The smaller the parts to be measured, the more complicated it becomes to position them ergonomically and detect their profile contours with sufficient sensitivity. Under these conditions, some of the methods described are no longer applicable or are very difficult to implement.

Moreover, it should also be mentioned that rotationally symmetrical parts may also feature milled geometries such as flats, slots, or transverse holes, which must also be measured and indexed to the optical axis.

US2021/0140873 discloses a modular device for positioning solutions, for dimensional and aesthetic inspection of small parts, by means of manual or automated inspection devices.

### BRIEF SUMMARY OF THE INVENTION

An aim of the present invention is to provide a mechanical device that enables easy positioning of the part to be inspected, so as to minimize the risk of the part falling from its support, to ensure maximum clearance around its contour regardless of its size, and to do so using a vertically oriented optical inspection means with direct vision (without image deflection).

Another aim of the present invention is to provide a mechanical device that allows the alignment and indexing of specific geometries in a repeatable manner, while minimizing the number of adjustments required to achieve proper alignment of the part to be inspected.

Another aim of the present invention is to provide a mechanical device having a certain degree of modularity, so as to allow the quick and repeatable interchange of various positioning and indexing elements for the parts, while still enabling fine adjustment of these elements.

Another aim of the present invention is to provide a mechanical device comprising multiple holders for multi-part inspection, while ensuring that the positioning and indexing adjustments apply to all parts in a precise and repeatable manner.

These aims are achieved in particular by means of a mechanical device for inspecting rotationally symmetrical parts or machined parts. The mechanical device is suitable for a vertical optical inspection apparatus comprising an image sensor and an observation surface. The mechanical device comprises a stationary base, a frame that is tiltably mounted on the stationary base, and one or more positioning elements mounted on the tiltable frame. The or each positioning element is arranged to receive at least one part of which an image can be captured by the image sensor of the vertical optical inspection apparatus when the stationary base of the mechanical device is positioned on the observation surface of said optical inspection apparatus. The mechanical device is arranged to allow the frame comprising the one or more positioning elements to tilt so as to position the axis of rotational symmetry of the or each rotationally symmetrical part, or a face to be inspected of the part, or of each machined part, perpendicularly to the optical axis of the vertical optical inspection apparatus.

In an embodiment, the optical inspection apparatus further comprises a light source.

In an embodiment, the tiltable frame comprises one or more stop elements. The or each stop element is aligned with the corresponding positioning element. The alignment of the part, or of each part positioned on the respective positioning element, is achieved by means of the stop element.

In an embodiment, the mechanical device further comprises a carriage arranged to slide relative to the stationary base and to receive, by attachment, the one or more stop elements.

In an embodiment, the positioning element, or each positioning element for the part or for each part comprises at least one surface whose material allows the passage of light having a wavelength that makes it possible to distinguish the contour of the parts to be measured.

In an embodiment, the positioning element, or each positioning element for the part or for each part is composed of at least two inclined surfaces located on either side of a plane of symmetry parallel to the optical axis. These two inclined surfaces form an angle between them ranging between 1° to 179°, and preferably between 10° and 160°.

In an embodiment, the mechanical device further comprises a removable frame adapted to be fixed to the tiltable frame. The removable frame includes receiving means for the positioning elements for the parts.

In an embodiment, the mechanical device further comprises a backlight secured to the stationary base and arranged to illuminate the part, or each part, through its positioning element.

In an embodiment, the positioning element or each positioning element for the part or for each rotationally symmetrical part is in the form of at least two rotatable cylindrical rollers arranged side by side, the rotation of which induces the rotation of the rotationally symmetrical part.

In an embodiment, the rotation of the cylindrical rollers is induced and regulated by a motorized device.

Another aspect of the invention relates to a vertical optical inspection apparatus comprising the mechanical device according to any one of the above-mentioned embodiments.

### BRIEF DESCRIPTION OF THE FIGURES

Examples of embodiments of the invention are shown in the description illustrated by the accompanying figures, in which:

FIG. 1 illustrates a perspective view of a positioning device, according to an embodiment, placed on an observation surface of a vertical optical inspection apparatus between the image sensor and the light source of the apparatus;

FIG. 2 illustrates a top view of the positioning device shown in FIG. 1;

FIG. 3 illustrates a partial view of FIG. 2 at the level of the positioning of a rotationally symmetrical part aligned in abutment and indexed by an abutment element according to an embodiment;

FIG. 4 illustrates a view of the positioning of a rotationally symmetrical part aligned in abutment by an abutment element according to another embodiment;

FIG. 5 illustrates a side view of the inclination of a positioning element for parts and all of the stop elements;

FIG. 6 shows an enlarged side view of the perpendicular positioning of a part in the positioning element shown in FIG. 5;

FIG. 7 shows a perspective view of a variety of stop elements;

FIG. 8 illustrates a perspective view of a removable frame mounted with positioning elements in the form of glass blades assembled in pairs, each forming a V-shaped profile, according to an embodiment;

FIG. 9 illustrates a perspective view of a removable frame mounted with a single positioning element in the form of a glass pane, according to another embodiment;

FIG. 10 illustrates a perspective view of a removable frame mounted with positioning elements in the form of pairs of transparent rotational cylinders, according to another embodiment;

FIG. 11 illustrates a perspective view of a positioning device that includes lighting attached to the stationary base, according to another embodiment, and

FIG. 12 illustrates a perspective view of a removable frame mounted with positioning elements in the form of pairs of transparent rotatable cylinders, with a device for motorizing the rotation of the cylinders, according to another embodiment.

### EXAMPLES OF EMBODIMENTS OF THE INVENTION

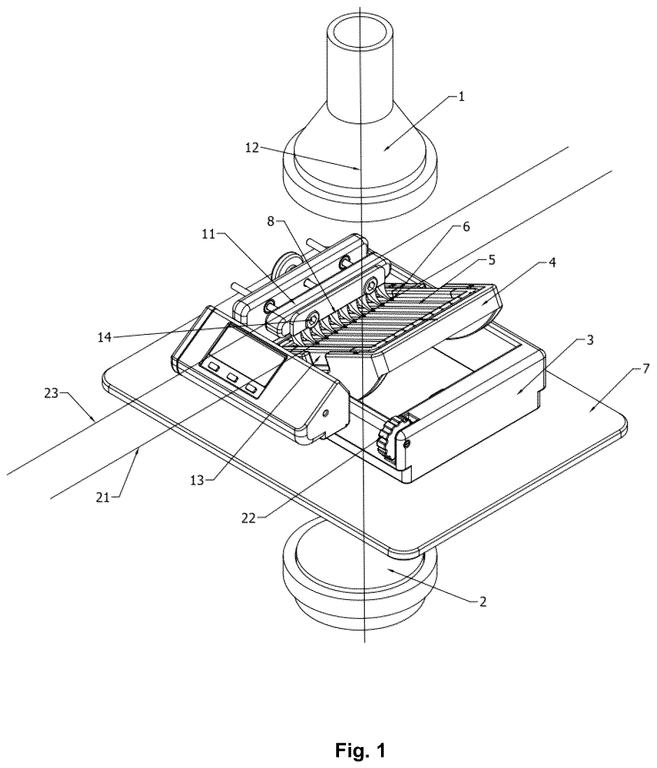

Referring to FIG. 1, the mechanical device is intended for use with an optical inspection apparatus comprising a photographic sensor 1, for example a camera, and incorporating a light source 2. FIG. 1 illustrates the basic principle of the invention, which consists of placing the mechanical device on an observation surface 7 of a vertical optical inspection device between the light source 2 and the camera 1, then tilting the part on which the rotationally symmetrical parts or machined parts 6 to be inspected are placed in order to correct any possible lack of perpendicularity and thus obtain accurate exposure of the contours of the parts to be measured from a direct vertical view.

According to an alternative embodiment, the optical inspection device does not have a light source. Instead, the observation surface 7 has a visual appearance that is chosen to contrast with the visual appearance of the parts to be inspected in order to clearly distinguish the contours of the parts to be measured. The observation surface may typically be white in color.

The mechanical device therefore has the advantage of facilitating the positioning and indexing of small parts that are difficult to handle and whose shapes and geometric relationships do not allow for precise positioning using other existing methods.

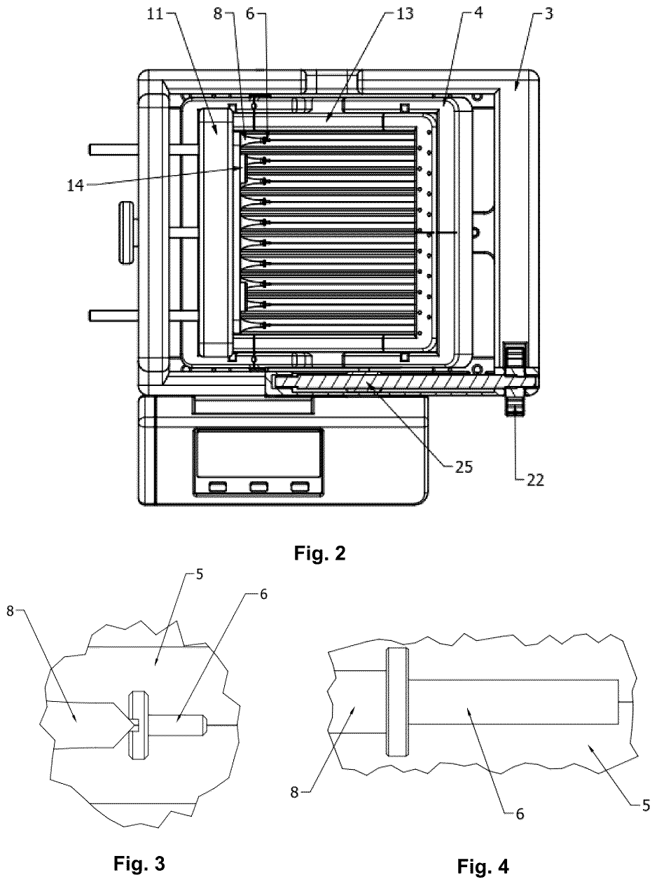

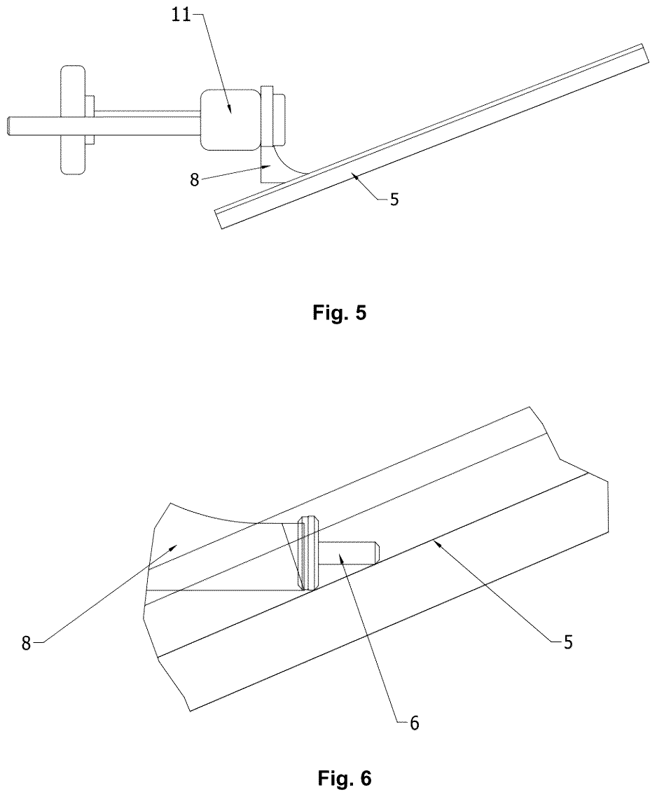

The mechanical device comprises, in particular, a stationary base 3 adapted to be placed on an observation surface 7 of the optical inspection apparatus horizontally with respect to the vertical axis 12 of the apparatus, a movable part 4 adjustable angularly with respect to the stationary base 3 and on which one or more positioning elements 5 intended to support the parts to be measured can be mounted. The mechanical device also comprises a movable carriage 11 which slides in the horizontal axis of the stationary base 3 and which supports stop elements 8 as illustrated in particular in FIGS. 2 to 7. More specifically, these stop elements 8 comprise a fixing part fixed to the carriage 11. These stop elements 8 make it possible to keep the axis of rotational symmetry of the rotationally symmetrical part 6, in particular, perpendicular to the vertical optical axis of the inspection apparatus, as illustrated in FIG. 6.

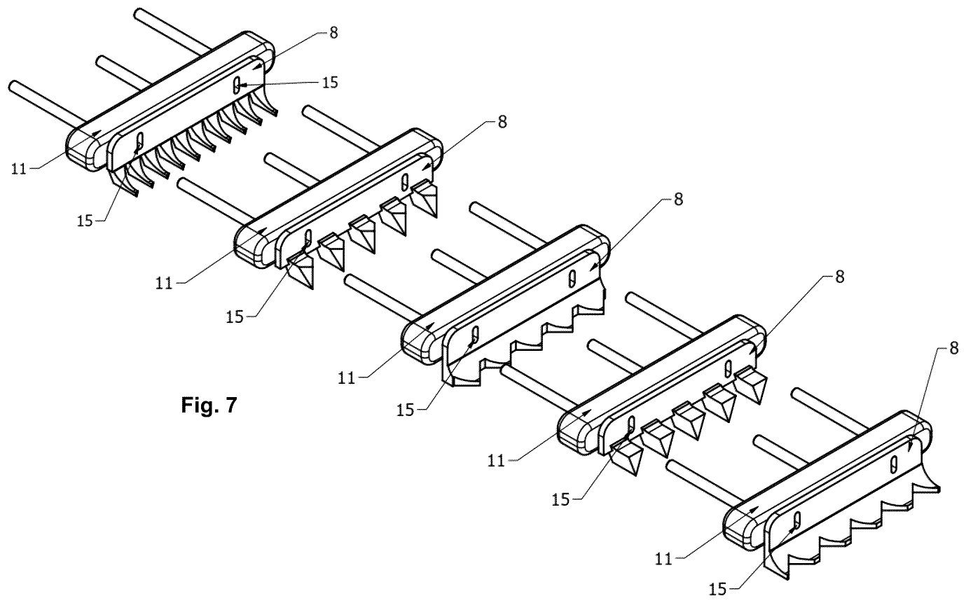

The fixing part comprises through-holes 15 (FIG. 7) whose shape allows lateral and height adjustment relative to the carriage 11 by means of clamping screws 14. These screws are used to lock the fastening part and the stop elements 8 onto the carriage 11 in the desired position within the degree of freedom allowed by the through-holes 15, which are oblong in shape in the example shown.

The regularity and repeatability of the focal distance in Z of all the parts is thus achieved by the stop elements 8 which are mounted on the sliding carriage 11 and which align the parts.

According to an embodiment, a tiltable frame 4 is mounted on the stationary base 3. The tiltable frame 4 is configured to receive a removable and interchangeable frame 13. With particular reference to FIG. 8, the positioning elements comprise transparent blades 9, 10 which are mounted on the removable frame 13 and which, depending on the design of the holders 19 of the frame 13, can be arranged in a more or less inclined manner facing each other, for example to form an angle of 120° between them. The longitudinal edges 20 of the blades are precisely beveled at the angle of the holders 19, so that they fit together perfectly and thus minimize the residual line visible when viewed vertically at their junction.

The rotationally symmetrical parts 6 are placed in the V-shaped profile created by the transparent blades 9, 10, which are inclined so that the largest of the support diameters is oriented toward the frame's axis of inclination, which corresponds to the lowest point during angular adjustment.

Referring in particular to FIG. 1, the carriage 11 is arranged to slide along the longitudinal axis of the stationary base 3, in order to allow all the parts to be aligned at the same distance from the axis 21 of inclination of the tiltable frame.

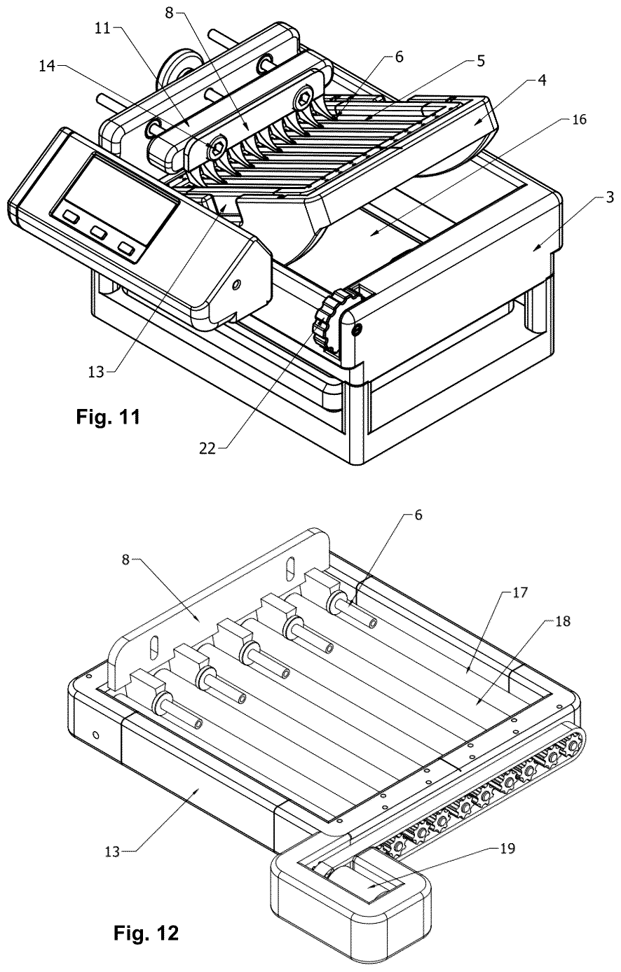

According to FIGS. 2 and 11, a manual adjustment mechanism 22 using a worm screw 25 or a motorized mechanism allows the tilting of the tiltable frame 4 to be adjusted until the part 6 to be inspected is positioned perpendicularly. The correct perpendicularity of the parts can be visually observed by assessing the focal sharpness at each end of the part. If the optical inspection apparatus' features allow it, the perpendicularity, or Z height, of the two focal points at the ends can be measured using the machine's autofocus functions. It is also possible, based on the technical drawing of the part, to calculate the angle formed by the two support points of the part in relation to its central axis, so that the inclination of the device can be directly adjusted to the corresponding angle.

Depending on the degree of inclination and the weight of the parts to be inspected, the stop element 8 may be retracted during measurement of the parts in order to completely clear their contours.

According to another embodiment, the sliding carriage 11, which is arranged to receive the fixing part of the stop elements 8, is equipped with a drum system (not shown) allowing several stop elements 8 of different configurations to be mounted on it, thus making it possible to quickly switch between various stop elements 8 by rotating the drum in accordance with the variety of parts to be measured.

According to another embodiment, the carriage 11 may be equipped with alignment elements that can be tilted by rotation about an axis 23 (FIG. 1) perpendicular to the direction of sliding of the carriage.

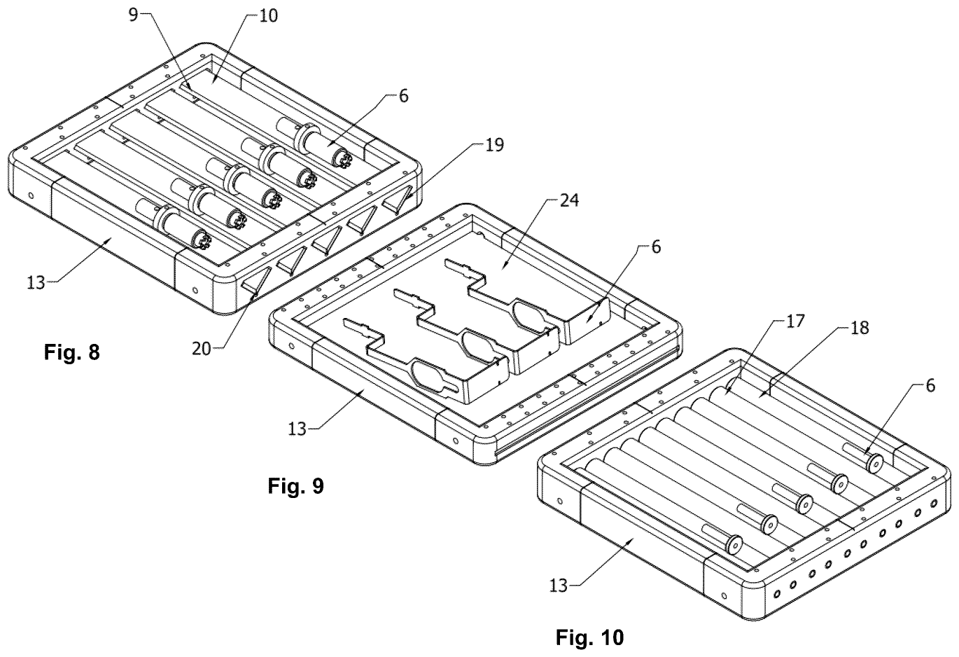

According to another embodiment illustrated in FIG. 9, the removable frame 13 has a flat surface for positioning machined parts, similar to a glass plate 24 for positioning parts other than rotationally symmetrical parts.

According to another embodiment illustrated in FIG. 10, the removable frame 13 comprises a surface for positioning the parts consisting of cylindrical rollers 17, 18 that allow the diascopic lighting of the optical inspection apparatus to pass through. These rollers 17, 18 may, for example, be transparent or sandblasted to avoid reflections due to the curvature of the cylinder. The rollers 17, 18 are rotatable, allowing the parts to be rotated for checking runout and concentricity. The rollers may be rotated manually or by motor 19.

According to the embodiment illustrated in FIG. 11, the mechanical device further comprises a backlight 16 secured to the stationary base 3 and arranged to illuminate the parts 6 through the positioning elements 5. The optical inspection apparatus may thus be devoid of a light source, while the inspection surface 7 may have any visual appearance.

The mechanical device may optionally also include a device (not shown) for motorizing the tilt of the tiltable frame 4.

1. Mechanical device for inspecting rotationally symmetrical parts or machined parts, the mechanical device being suitable for a vertical optical inspection apparatus comprising an image sensor and an observation surface, the mechanical device comprising a stationary base, a frame that is tiltably mounted on the stationary base, and one or more positioning elements mounted on the tiltable frame, the or each positioning element being arranged to receive at least one part of which an image can be captured by the image sensor of the vertical optical inspection apparatus when the stationary base of the mechanical device is positioned on the observation surface of said apparatus, wherein the mechanical device is arranged to allow the frame comprising the one or more positioning element to tilt so as to position the axis of rotational symmetry of the part or each rotationally symmetrical part or a face to be inspected of the part or each machined part perpendicularly to the optical axis of the vertical optical inspection apparatus.

2. Mechanical device of claim 1, wherein the tiltable frame comprises one or more stop elements, the or each stop element being aligned with the corresponding positioning element, the alignment of the part or each part positioned on the respective positioning element being achieved by said stop element.

3. Mechanical device of claim 2, further comprising a carriage arranged to slide relative to the stationary base and to receive, by attachment, the or each stop element.

4. Mechanical device of claim 1, wherein the positioning element or each positioning element for the part or for each part comprises at least one surface whose material allows the passage of light having a wavelength that makes it possible to distinguish the contours of the parts to be measured.

5. Mechanical device of claim 1, wherein the positioning element or each positioning element for the part or for each part is composed of at least two inclined surfaces located on either side of a plane of symmetry parallel to the optical axis, and forming an angle between them ranging between 1° and 179°, preferably between 10° and 160°.

6. Mechanical device of claim 1, further comprising a removable frame adapted to be fixed to the tiltable frame, the removable frame comprising receiving means for the positioning elements for the parts.

7. Mechanical device of claim 1, further comprising a backlight secured to the stationary base and arranged to illuminate the or each part through its positioning element.

8. Mechanical device of claim 1, wherein the positioning element or each positioning element for the part or each rotationally symmetrical part is in the form of at least two rotatable cylindrical rollers arranged side by side, the rotation of which induces the rotation of the rotationally symmetrical part.

9. Mechanical device of claim 8, wherein the rotation of the cylindrical rollers is induced and regulated by a motorized device.

10. Vertical optical inspection apparatus comprising the mechanical device of claim 1.
